(19) United States
(12) Patent Application Publication
(10) Pub. No.: US 2016/0048814 A1
(43) Pub. Date: Feb. 18, 2016

(54) SPLIT-FEE MERCHANT PAYMENT PLATFORM SYSTEM AND METHOD

(71) Applicant: Laura Wagner, Los Angeles, CA (US)

(72) Inventor: Laura Wagner, Los Angeles, CA (US)

(21) Appl. No.: 14/827,336

(22) Filed: Aug. 17, 2015

Related U.S. Application Data
(60) Provisional application No. 62/038,217, filed on Aug. 16, 2014.

(51) Int. Cl. G06Q 20/10

(52) U.S. Cl. CPC G06Q 20/102

(57) ABSTRACT

A system and method of processing electronic funds through a split-fee merchant payment platform is provided. The present system and method is especially suitable for service businesses accepting virtual (non-face-to-face) payments such as electronic checks, debit or credit cards. The platform has a virtual “real-time” merchant boarding process which therein allows the merchant to start accepting electronic payment transactions almost instantaneously. The present split-fee merchant payment platform system and method also allows merchants to pick between, at least, three split-fee options: merchants may electively (i) eat (absorb) the usual 3% fees, (ii) share the 3% in fees with their customer, or, (iii) pay zero and pass 3% in fees to their customer. Finally, the present platform system and method allows a merchant to receive payment 365 days a year.

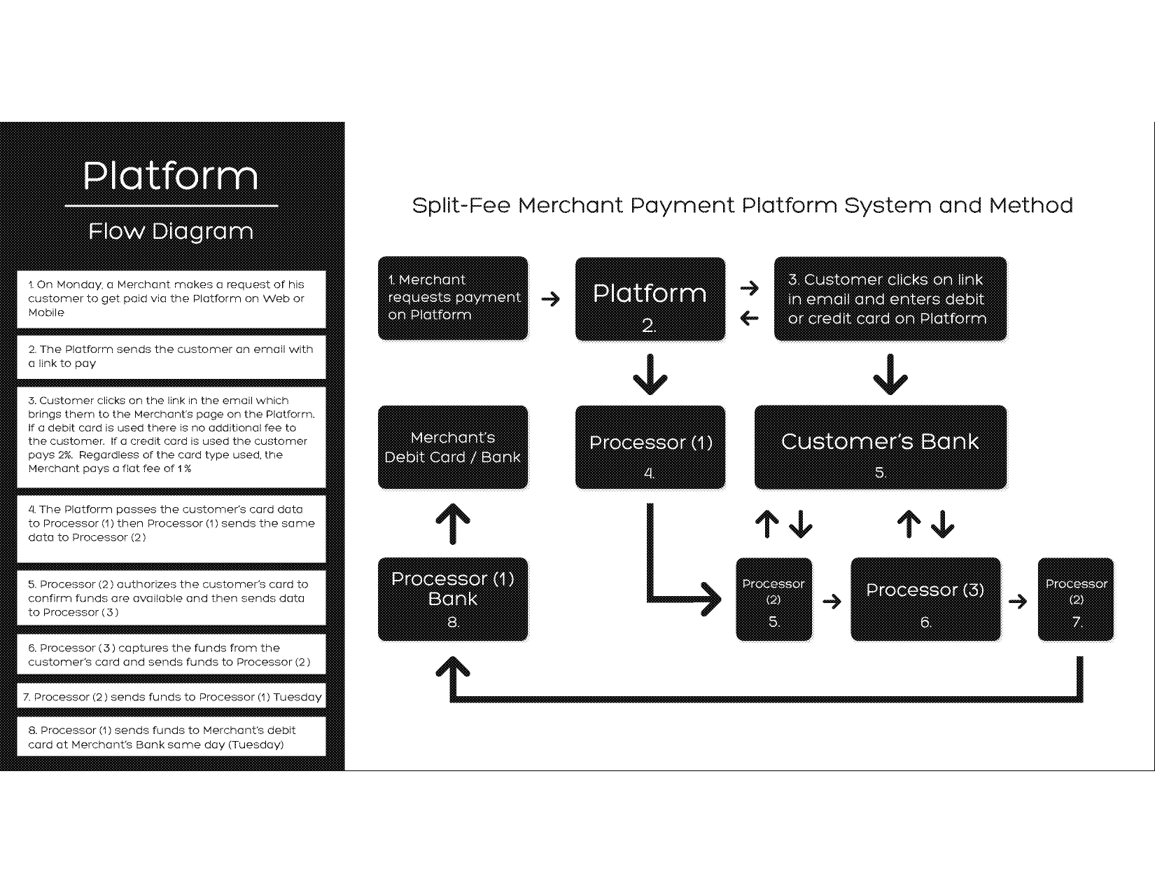

### CROSS REFERENCE TO RELATED APPLICATIONS

The following application is based on and claims the priority benefit of U.S. provisional application Ser. No.: 62/038,217 filed Aug. 16, 2014 currently co-pending; the entire contents of which are incorporated by reference.

### BACKGROUND OF THE INVENTION

A system and method of processing electronic funds through a split-fee merchant payment platform is provided. Although the present system may be used by any business, the present processing platform system is especially suitable for service businesses accepting virtual (non-face-to-face) payments such as electronic checks, debit or credit cards. The present system and method allows for a virtual “real-time” merchant boarding process which therein allows the merchant to start accepting electronic payment transactions almost instantaneously after signing up with the platform. The present split-fee merchant payment platform system is both a gateway and a merchant account combined and method also allows merchants to pick between, at least, three split-fee options: merchants may electively (i) eat (absorb) the usual 3% fees, (ii) share the 3% in fees with their customer, or, (iii) pay zero and pass 3% in fees to their customer. Finally, the present platform system and method allows a merchant to receive payment next day, 365 days a year by posting an original credit to the merchant's existing debit card at the merchant's usual bank.

Over the years, attempts have been made to provide easy online credit card processing for merchants. For example, U.S. Pat. No. 8,046,305 to Barnett et at discloses a method and apparatus for processing credit card transactions over the Internet having an application program interface (API) that converts a simple ASCII transaction message from the merchant to the message spec required by the transaction processor. The API also encrypts the transaction message so that the transaction is secure over the Internet and manages the message traffic between the merchant and transaction processor. In a second preferred embodiment, a merchant sends a simple ASCII transaction message via a SSL (secure sockets layer) Internet connection. In preferred embodiments, redundant connections are set up between the merchant and the transaction processor, allowing a transaction to continue being processed if one of the connections fails.

Further, U.S. Pat. No. 6,072,870 to Nguyen discloses a method of a transmission of data between a plurality of computer systems over a public communication system, such as the Internet. Secure transmission of data is provided from a customer computer system to a merchant computer system, and for the further secure transmission of payment information from the merchant computer system to a payment gateway computer system. The payment gateway system formats transaction information appropriately and transmits the transaction to the particular host legacy system. The host legacy system evaluates the payment information and returns a level of authorization of credit to the gateway which packages the information to form a secure transaction which is transmitted to the merchant which is in turn communicated to the customer by the merchant. The merchant can then determine whether to accept the payment instrument tendered or deny credit and require another payment instrument. An architecture that provides support for additional message types that are value-added extensions to the basic SET protocol is provided by a preferred embodiment of the invention.

In addition, previous payment gateway solutions require the merchant to obtain an additional merchant account with a payment processor (at an average cost of 2.9%+$0.30 per transaction) in order to get paid. Payment gateways typically charge merchant a month fee of around $30 and often per transaction fees of around $0.10 per transaction (in addition to the 2.9%+$0.30 charged by the processor). However, these patents fail to describe a value-added split-fee merchant platform that combines the functionality of a merchant payment gateway with a merchant account combined as described herein by the present system and method.

### SUMMARY OF THE INVENTION

A system and method of processing electronic funds through a split-fee merchant payment platform is provided. Although the present system may be used by any business, the present processing platform system is especially suitable for service businesses accepting virtual (non-face-to-face) payments such as electronic checks, debit or credit cards. The present system and method allows for a virtual “real-time” merchant boarding process which therein allows the merchant to start accepting electronic payment transactions almost instantaneously after signing up with the platform. The present split-fee merchant payment platform system is a gateway and merchant account combined and method also allows merchants to pick between, at least, three split-fee options: merchants may electively (i) eat (absorb) the usual 3% fees, (ii) share the 3% in fees with their customer, or, (iii) pay zero and pass 3% in fees to their customer. Finally, the present platform system and method allows a merchant to receive payment 365 days a year by posting an original credit to the merchant's existing debit card at the merchant's usual bank.

It is the combination of the above elements that make the present platform system and method unique. In particular: (i) the ability of the platform to provide an almost “real-time” boarding process for the merchant, (ii) the ability of the merchant to selectively and specifically split the usual 3% processing fees between the merchant and the customer, or, to add 3% to the customer making the merchant's cost zero and (iii) the ability for the merchant to get paid the next day by posting an original credit the merchant's existing debit card. Additional benefits of utilizing the present platform system and method are also discussed below.

Payment gateways are often referred to as virtual terminals. Merchants using virtual terminals typically take card numbers by phone and hand-enter the card numbers to process the transaction into the virtual terminal. In contrast, the present platform system and method provides a way for merchants to (i) never have to manually enter card numbers into a platform and (ii) further blocks the merchant from actually ever seeing the card number (which provides maximum security for both merchants and customers). Moreover, customer's card numbers (should the customer elect to do so) can be stored securely in the present platform and charged by the merchant as needed in a tokenized manor so that neither party must spend more than, literally, a few seconds, to complete a repeat or recurring transaction.

For a more complete understanding of the above listed features and advantages of the split-fee merchant payment platform, reference should be made to the detailed description and any drawings. Further, additional features and advantages of the invention are described in, and will be apparent from, the detailed description of the preferred embodiments.

### DRAWINGS

The FIGURE illustrates a Flow Diagram of a transaction utilizing the present method.

### DETAILED DESCRIPTION OF THE PREFERRED EMBODIMENTS

A system and method of processing electronic funds through a split-fee merchant payment platform is provided. Although the present system may be used by any business, the present processing platform system is especially suitable for service businesses accepting virtual (non-face-to-face) payments such as electronic checks, debit or credit cards. The present system and method allows for a virtual “real-time” merchant boarding process which therein allows the merchant to start accepting electronic payment transactions almost instantaneously after signing up with the platform. The present split-fee merchant payment platform system is a gateway and a merchant account combined and method also allows merchants to pick between, at least, three split-fee options: merchants may electively (i) eat (absorb) the usual 3% fees, (ii) share the 3% in fees with their customer, or, (iii) pay zero and pass 3% in fees to their customer. Finally, the present platform system and method allows a merchant to receive payment, next day, 365 days a year by posting an original credit to the merchant's existing debit card at the merchant's usual bank.

Typically, perspective merchants must fill out paperwork with a “merchant services provider” in order to get approved for a merchant account in which to process electronic checks, debit or credit cards. This process is called “boarding.” The typical boarding application process takes quite a bit of the merchant's personal time. For instance, a perspective merchant usually must provide a copy of his/her business license, driver's license, tax returns, etc. Further, the overall approval time by merchant services companies is rarely less than two business days.

I) Virtual “Real-Time” Boarding Process

The present method provides for an almost “real-time” merchant boarding process in the following way: (i) a perspective merchant enters approximately ten pieces of information (social security, tax ID, etc) into a host website (the “platform”) and clicks to agree to the terms. In almost “real-time”, the platform checks out the merchant's identity, on-line reputation, social media presence and can even run a criminal background check. If sufficient information can be gathered, an instant email approval is sent. If not, an email is sent with a link where additional support documents may be uploaded by the perspective merchant. To accomplish “real-time” boarding, the platform is integrated via API with multiple third party providers that specialize in aggregating massive amounts of data. In literally seconds after a merchant clicks to agree to the terms and conditions (including his/her approval for the information provided to be checked) an approval score is created by the platform. Should the score be, for example, over 8 (out of 10), the merchant will automatically be approved. If less than 8, more information will be required, however, the score drops to, for example, a 6 if additional information is required. The need for additional information flags the platform of the challenge in confirming the identity of the person signing or of the business (which may be fictional). After providing additional documentation (like a business license), the merchant may be conditionally approved but will likely need to limit their processing volume the first few months.

II) Selective and Specific Split-Fee Election by Merchant

Another drawback of typical credit and debit card processing platforms is that usually service merchants who don't physically swipe cards generally pay around 3% to accept Visa, MasterCard or American Express cards. Legacy payment platforms are incapable of doing anything other than charging the merchant the 3% fees. The present system and method allows for the selective and specific splitting of the usual 3% (approximate) fees by the merchant between the merchant and their customer, or, gives the merchant the option to charge all 3% to the customer and pay zero.

The present system and method provides the merchant with three unique options not available with any other merchant payment platform. In particular, the merchants in the present system and method may selectively and specifically (i) eat (absorb) the usual 3% fees, (ii) share the 3% in fees with their customer, or, (iii) pay zero and pass 3% in fees to their customer. In particular, when the merchant receives an order for a good or service (usually a services), the merchant of the present system and method takes the First Step of: entering in the cost of the goods/services into an input field and then takes the Second Step of: selectively checking a box representing that the merchant, for this specific transaction, will: (i) absorb all the transactional processing fees, (ii) split and share the transactional processing fees or (iii) pay none of the transactional processing fees and therein pass all the transactional processing fees to the customer. Preferably, the customer is made aware of the above-option selected by the merchant; however, in one alternative embodiment, the customer is not aware of the selection made by the merchant and merely receives a final invoice.

Passing fees along to customers is a desirable feature in high-ticket situations such as air conditioning sales. If an air conditioning merchant elects to pass on all of the 3% fees to a customer paying an initial $1,000 deposit with a card, the customer would pay $1,030 and the merchant would pay zero. Thereafter, the same customer could be set up to be charged monthly payments of $300 where the merchant agrees to eat 1% and the customer agrees to eat 2% ($6) to be able to use a card, thus, the customer would pay $206 monthly and the merchant would absorb $3 (1%) monthly instead of $9 (3%) as he/she would have to eat with virtually every merchant services provider. Further, the merchant may instead absorb all the 3% processing fees for the $50 per month maintenance contract. As a result, the merchant has the freedom to make the election for a specific transaction. More specifically, it is the merchant, not the customer who makes the election of how the transactional processing fees are paid. The customer agrees to the extra fees (or not) when they agree to the total amount shown (which shows the fees separately to be certain the customer agrees)

Current merchant services providers have legacy technology that limits their ability to do anything but charge 3% in fees directly to the merchant. More specifically, no merchant payment platform currently exists which allows the splitting of the 3% fees between the merchant and the customer. The present system and method also allows the customer to pay the merchant with an electronic check or debit card for free or to pay with a credit card for an addition (approximate) 2% fee.

For example, an attorney merchant needing to collect $1,000 from his client (or “customer”) may use the present platform to request $1,000 from the client by entering the client's name, email and $1,000 into the platform online or via a mobile app. The client would receive the merchant's branded request via email and would click on the link sent to the client to make the payment at the merchant's branded hosted Payment Card Industry (“PCI”) compliant payment page on the platform. More specially, the merchant branded page may be, for example, a link to the ABC LAW FIRM. If the client elects to pay with a debit card, no additional fee would be added; however, if the client elects to pay with a credit card, an additional 2% fee would be added ($1,020) to the total transaction amount ($1,020). In either scenario, the attorney will pay only a flat 1% ($10 verses $30) to get paid via ACH, credit or debit card. The usual total of approximately 3% therefore will be collected on credit card payments—1% from the merchant and 2% from the customer/client and a total of 1% will be collected on debit card payments—1% from the merchant and 0% from the customer/client. As a result, the cost of processing the transaction would have been split to have made the transaction more-fair to both the attorney merchant and the customer/client.

In an embodiment, the present system and method provides that (i) a merchant sends an initial request to a customer via the online platform or the platform's mobile app, (ii) the customer enters their payment method of choice (a debit card, a credit card or their bank account information to go through as an electronic check), (iv) the customers chooses to make a one-time payment or to allow the merchant to access their payment method when necessary (iv) the initial payment method provided by the customer is debited by the platform and the funds are moved onto the merchant's existing debit card next day at the merchant's existing bank, (v) if the merchant agrees to let the merchant store the card on future approved transactions, the next time the merchant wishes to charge the same customer the merchant will simply locate the customer's name, enter the amount (if different than the first transaction). The customer receives a simultaneous text and email asking “OK for ABC Law to charge $750 to your card ending in #XXXX?

The customer can click yes, no, or add new card. If “Add New Card” is selected, after they add a new card they are asked again if it's OK to charge card ending in #XXXX.

III) Next Day Payment Year Round

In addition to the present electronic funds transferring platform system and method providing a virtual “real-time” boarding process and a split-fee option, the present system and method may also move monies from the customer's card to the merchant's bank account in two ways (i) it can move monies via the merchant's bank account and in this case, funds will arrive in two business days. A unique feature of the present system and method is real-time payment to the merchant's existing debit card at the merchant's existing bank (not into a wallet type account); so, essentially, a deposit is realized in the merchant's bank account the next business day. In this option, the merchant will see an instant credit to their debit card in minutes, 7 days a week, even on holidays. The industry standard for receiving money is generally two business days; the present “real-time” payment feature of the present system and method is unique in the merchant services space.

In addition to the above-listed features of the present split-fee payment platform system and method, additional benefits of the present platform system and method include:

I) Gateway and Merchant Account combined: Typically merchants who don't swipe cards must not only obtain a merchant account but also a gateway account to authorize cards online. The present platform system and method provides for a gateway and merchant account combined so no additional gateway account is required.

II) Gross deposits on each transaction: Typically, on a $100 sale, merchants receive $97 ($100 less 3%). The present platform system and method provides for the gross settlement of $100 to aid in reconciliation. Then, only at the end of the month is the 3% is debited from the merchant's bank account on the total dollars processed that month. As a result, the merchant has more cash-flow in his/her bank account during the month.

III) Security: All merchants that accept cards are required to become PCI complaint and the majority of merchant providers charge $79-$149 for annual fees for PCI compliance fees. The present platform system and method conceals card numbers of customers from merchants making it one of the most secure platforms available. Further, no fees are charged to merchants for PCI compliance.

IV) Stored Card Numbers: the present platform system and method allows for a merchant to process repeat or recurring transactions: In the present platform system and method, all card numbers are tokenized for maximum security and thus can be securely stored and accessed for repeat or recurring transactions.

V) Branded: Unlike the majority of merchant payment platforms where a gateway and merchant account are combined, in the present platform system and method, only the merchant's brand is visible throughout the method. Personal: The merchant may add a personal note to send along in the email and can also attach invoices.

VI) Pay-as-they-process: The present platform system and method uniquely charges merchants only for the processed transactions each month. No statement fees, cancellation fees, PCI fees or minimums are charged to the merchant. The relationship is at-will so merchants can start and stop any time without penalty.

VII) Chargeback Assistance: Chargebacks plague small merchants, especially card-not-present merchants. Small merchants typically do not ask customers to sign documents protecting the merchant from chargebacks. By the present platform system and method, before a payment is made, a customer must click-to-sign the platform's terms of service. The terms of service state that the customer must contact the merchant first, by email, if they become dissatisfied. Statistics show that 88% of customers call their bank to chargeback a transaction (instead of contacting the merchant). The platform notifies the attorney (merchant) in real-time if a customer attempts a chargeback. The attorney can (i) initiate an instant credit to the customer's card, or, (ii) have, 72 hours to work out the dispute with the customer. In either case, (a credit or dispute resolution) the merchant will avoid negative marks for the chargeback from Visa, MasterCard or the like. Should the merchant decide to fight a dispute, the platform can handle the cumbersome dispute process completely. No fee is charged for handling the dispute process unless the dispute is settled in the merchant's favor. In contrast, payment processors instantly charge merchants $35-$50 per chargeback, offer no resolution period and offer no collection support to the merchant.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

1. An electronic funds transactional payment platform system comprising:
a providing an Internet-connected computer wherein the computer is controlled by a pre-qualified merchant selling a good or a service to a customer;
allowing the merchant to enter in the subtotal cost of the good or service charged by the merchant to the customer into an electronic invoice to be paid by the customer; and
requiring the merchant to select via the Internet-connected computer between one of three options wherein the merchant:
(i) absorbs all the processing fees incurred by utilizing the electronic funds transactional payment platform; or
(ii) splitting and sharing the processing fees incurred by utilizing the electronic funds transactional payment platform between the merchant and the customer; or
(iii) paying none of the processing fees incurred by utilizing the electronic funds transactional payment platform and therein passing all the processing fees incurred by utilizing the electronic funds transactional payment platform directly to the customer.

2. The electronic funds transactional payment platform system of claim 1 wherein the pre-qualified merchant selects between the three options prior to passing on a final invoice to the customer and wherein the final invoice reflects the option selected by the pre-qualified merchant.

3. The electronic funds transactional payment platform system of claim 2 wherein customer is not made aware of the selection made by the pre-qualified merchant.

4. The electronic funds transactional payment platform system of claim 1 wherein funds paid by the customer to settle the invoice are paid via a debit card, credit card or electronic check.

5. The electronic funds transactional payment platform system of claim 1 wherein the merchant becomes pre-qualified to or rejected from becoming a merchant in the electronic funds transactional payment platform within five minutes of completing an on-line survey and by agreeing to terms and conditions previously supplied by the payment platform and by undergoing an aggregate of background screening by third parties.

6. The electronic funds transactional payment platform system of claim 1 wherein the merchant is paid by the payment platform immediately the day after the invoice is settled by the customer.
